(19) United States
(12) Patent Application Publication
(10) Pub. No.: US 2026/0005608 A1
(43) Pub. Date: Jan. 1, 2026

(54) VOLTAGE CONVERTER AND VOLTAGE CONVERSION CIRCUIT INCLUDING MULTIPLE SWITCHES AND FLOATING CAPACITORS

(71) Applicant: Samsung Electronics Co., Ltd., Suwon-si (KR)

(72) Inventors: Jeewook CHANG, Suwon-si (KR); Sanghoon LEE, Suwon-si (KR); Sanghee KANG, Suwon-si (KR); Hocheol CHUNG, Suwon-si (KR)

(73) Assignee: Samsung Electronics Co., Ltd., Suwon-si (KR)

(21) Appl. No.: 19/226,663

(22) Filed: Jun. 3, 2025

(30) Foreign Application Priority Data
Jun. 28, 2024 (KR) 10-2024-0085740
Oct. 29, 2024 (KR) 10-2024-0149862

(51) Int. Cl. H02M 3/158; H02M 1/00; H02M 1/088

(52) U.S. Cl. CPC H02M 3/158; H02M 1/0095; H02M 1/088

(57) ABSTRACT

A voltage converter including switches includes first to fourth capacitors, each connected to an output node configured to output a charging current, and a switch controller configured to control the switches. The switch controller is configured to control the switches in response to a first voltage control signal, based on a first input voltage, having a first ratio with respect to a charging voltage based on the charging current, being applied from a voltage source, to alternatively perform a first operation of connecting the first capacitor to the voltage source, the third capacitor to ground, and the second capacitor and the fourth capacitor in series between the ground and the output node, and a second operation of connecting the first capacitor and the third capacitor in series between the ground and the output node, connecting the second capacitor to the voltage source, and connecting the fourth capacitor to the ground.

### CROSS-REFERENCE TO RELATED APPLICATION(S)

This U.S. non-provisional application claims priority under 35 USC § 119 to Korean Patent Application Nos. 10-2024-0085740, filed on Jun. 28, 2024 and 10-2024-0149862, filed on Oct. 29, 2024, in the Korean Intellectual Property Office, the disclosures of which are herein incorporated by reference in their entirety.

### BACKGROUND

Example embodiments relate to voltage converters and voltage conversion circuits, each including a plurality of switches and a plurality of floating capacitors.

Electronic devices generate and use various levels of voltage internally. Mobile devices powered by batteries, such as smartphones and tablets, may use an even wider range of voltages.

When a mobile device is connected to a charger, the mobile device may generate additional voltages, for example, one for charging a battery from an external power supply and another for supplying power internal components. Additionally, when a mobile device is connected to a device receiving power from a mobile device such as an On-The-Go (OTG) device, the mobile device may generate a voltage from a battery to supply power to an external device.

A mobile device may generate a plurality of voltages, and therefore, it may be beneficial to include a plurality of voltage converters. This results in an increase in both manufacturing costs and the overall size of the mobile device.

### SUMMARY

Example embodiments provide voltage converters outputting a charging current from a plurality of different voltages.

According to some example embodiments, a voltage converter including a plurality of switches includes a first floating capacitor and a second floating capacitor, a third floating capacitor and a fourth floating capacitor, each connected to an output node configured to output a charging current, and a switch controller configured to control the plurality of switches. The switch controller may be configured to control the plurality of switches in response to a first voltage control signal, based on a first input voltage, having a first ratio with respect to a charging voltage based on the charging current, being applied from a voltage source, to alternatively perform a first operation of connecting the first floating capacitor to the voltage source, connecting the third floating capacitor to ground, and connecting the second floating capacitor and the fourth floating capacitor in series between the ground and the output node, and a second operation of connecting the first floating capacitor and the third floating capacitor in series between the ground and the output node, connecting the second floating capacitor to the voltage source, and connecting the fourth floating capacitor to the ground.

According to some example embodiments, a voltage conversion circuit including a plurality of switches includes a first switch and a second switch connected in series between a voltage source and ground, a first floating capacitor connected between the first switch and the second switch, a third switch and a fourth switch connected in parallel to the first switch and the second switch between the voltage source and the ground, a second floating capacitor connected between the third switch and the fourth switch, a fifth switch connected between a first node between the first switch and the first floating capacitor and a second node between the second floating capacitor and the fourth switch, a sixth switch connected between a third node between the first floating capacitor and the second switch and a fourth node between the third switch and the second floating capacitor, a seventh switch, an eighth switch, a ninth switch, and a tenth switch connected in series between the third node and the ground, an eleventh switch, a twelfth switch, a thirteenth switch, and a fourteenth switch connected in series between the second node and the ground, a fifteenth switch connected between the first node and a fifth node between the seventh switch and the eighth switch, a sixteenth switch connected between the fourth node and a sixth node between the eleventh switch and the twelfth switch, a third floating capacitor connected between the fifth node and a seventh node between the ninth switch and the tenth switch, and a fourth floating capacitor connected between the sixth node and an eighth node between the thirteenth switch and the fourteenth switch.

According to some example embodiments, a voltage converter includes a voltage conversion circuit including a plurality of switches and a switch controller connected to the voltage conversion circuit and configured to control the plurality of switches. The voltage conversion circuit may include a first floating capacitor and a second floating capacitor and a third floating capacitor and a fourth floating capacitor, each connected to an output node. The switch controller may be configured to control the plurality of switches such that the voltage conversion circuit outputs a charging current from a first input voltage, based on a voltage source generating the first input voltage, to alternately perform a first operation of connecting the first floating capacitor to the voltage source, connecting the third floating capacitor to ground, and connecting the second floating capacitor and the fourth floating capacitor in series between the ground and the output node, and a second operation of connecting the first floating capacitor and the third floating capacitor in series between the ground and the output node, connecting the second floating capacitor to the voltage source, and connecting the fourth floating capacitor to the ground.

According to some example embodiments, a method of operating a voltage converter includes determining to alternatively perform first and second operations based on receiving a first input voltage, having a first ratio with respect to a charging voltage based on a charging current, being applied from a voltage source, the first operation including connecting a first floating capacitor to the voltage source, connecting a third floating capacitor to ground, and connecting a second floating capacitor and a fourth floating capacitor in series between the ground and an output node, and the second operation including connecting the first floating capacitor and the third floating capacitor in series between the ground and the output node, connecting the second floating capacitor to the voltage source, and connecting the fourth floating capacitor to the ground.

According to some example embodiments, the method may further include performing the first operation using a (1-1)-th operation signal having a duty ratio and performing the second operation using a (1-2)-th operation signal having the duty ratio and an inverse phase to the (1-1)-th operation signal.

### BRIEF DESCRIPTION OF DRAWINGS

FIG. 1 is a block diagram of a voltage converter according to some example embodiments.

FIG. 2A is a circuit diagram of a voltage converter according to some example embodiments.

FIG. 2B is a circuit diagram of a voltage conversion circuit including a first gate driver to a fourth gate driver according to some example embodiments.

FIG. 3A is a circuit diagram illustrating a flow of current in a voltage conversion circuit while a switch controller performs a first operation according to some example embodiments.

FIG. 3B is a circuit diagram illustrating a flow of current in the voltage conversion circuit while the switch controller performs a second operation according to some example embodiments.

FIG. 3C is a diagram illustrating voltage control signals controlling the switch controller to perform the first operation and the second operation according to some example embodiments.

FIG. 4 is a table illustrating the types and numbers of elements included in each of a voltage converter according to comparative examples and a voltage converter according to some example embodiments.

FIG. 5A is a circuit diagram illustrating a flow of current in the voltage conversion circuit while the switch controller performs a third operation according to some example embodiments.

FIG. 5B is a circuit diagram illustrating a flow of current in the voltage conversion circuit while the switch controller performs a fourth operation according to some example embodiments.

FIG. 6 is a diagram illustrating voltage control signals controlling the switch controller to perform the third operation and the fourth operation, and signals controlling each of a fifth switch and a sixth switch according to some example embodiments.

FIG. 7A is a circuit diagram illustrating a flow of current in the voltage conversion circuit while the switch controller performs a fifth operation according to some example embodiments.

FIG. 7B is a circuit diagram illustrating a flow of current in the voltage conversion circuit while the switch controller performs a sixth operation according to some example embodiments.

FIG. 8A is a circuit diagram illustrating a flow of current in the voltage conversion circuit while the switch controller performs the fifth operation according to some example embodiments.

FIG. 8B is a circuit diagram illustrating a flow of current in the voltage conversion circuit while the switch controller performs the sixth operation according to some example embodiments.

FIG. 9 is a circuit diagram of a voltage converter further including a plurality of additional switches and a plurality of floating capacitors according to some example embodiments.

FIG. 10 is a block diagram of a mobile terminal including a voltage converter according to some example embodiments.

### DETAILED DESCRIPTION

Hereinafter, example embodiments will be described with reference to the accompanying drawings.

The term “first,” “second,” or the like, used herein may modify various elements regardless of the order and/or priority thereof, and is used only for distinguishing one element from another element, without limiting example embodiments.

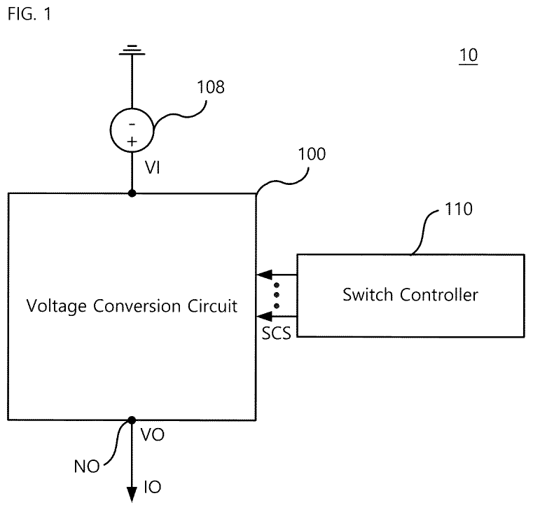

FIG. 1 is a block diagram of a voltage converter according to some example embodiments.

Referring to FIG. 1, a voltage converter 10 according to some example embodiments may include a voltage conversion circuit 100, connected to a voltage source 108, and a switch controller 110.

According to some example embodiments, the voltage conversion circuit 100 may receive an input voltage VI from the voltage source 108 to output a charging current IO.

The voltage conversion circuit 100 may receive the input voltage VI from the voltage source 108.

For example, the voltage conversion circuit 100 may receive the input voltage VI having a specified ratio with a charging voltage VO from the voltage source 108.

For example, the voltage conversion circuit 100 may receive the input voltage VI having a value of 3 times the charging voltage VO from the voltage source 108. For example, the voltage conversion circuit 100 may receive the input voltage VI having a value of 4 times the charging voltage VO from the voltage source 108.

Furthermore, the voltage conversion circuit 100 may output the charging current IO based on the charging voltage VO through an output node NO based on the input voltage VI.

For example, the voltage conversion circuit 100 may convert the input voltage VI, applied from the voltage source 108, into a charging voltage VO having a specified ratio with the input voltage VI.

For example, the voltage conversion circuit 100 may convert the input voltage VI, applied from the voltage source 108, into a charging voltage VO having a value of ⅓ of the input voltage VI.

Furthermore, the voltage conversion circuit 100 may output the charging current IO based on the charging voltage VO through the output node NO.

The voltage converter 10 may include a switch controller 110 connected to the voltage conversion circuit 100. Also, the voltage conversion circuit 100 may include a plurality of switches.

The switch controller 110 may be electrically connected to the plurality of switches included in the voltage conversion circuit 100.

According to some example embodiments, the switch controller 110 may control at least a portion of the plurality of switches included in the voltage conversion circuit 100 such that the voltage conversion circuit 100 outputs the charging current IO.

For example, the switch controller 110 may control each of the plurality of switches included in the voltage conversion circuit 100 using at least one switch control signal SCS.

For example, the switch controller 110 may perform a first operation of turning on a portion of the plurality of switches such that the voltage conversion circuit 100 outputs the charging current IO from a first input voltage having a voltage value of a first integer multiple (for example, 3 times) of the charging voltage VO.

For example, the switch controller 110 may also perform a second operation of turning on a portion of the plurality of switches such that the voltage conversion circuit 100 outputs the charging current IO from the first input voltage.

The switch controller 110 may turn on at least some different switches during the first operation and the second operation.

Also, the switch controller 110 may repeatedly and alternately perform the first operation and the second operation at the same interval.

The switch controller 110 may alternately perform the first and second operations in response to two signals that have the same duty ratio and are in opposite phases.

For example, the voltage converter 10 may alternately and repeatedly perform operations of controlling the voltage conversion circuit 100 in different states through the switch controller 110. Accordingly, the voltage converter 10 may maintain a constant input voltage VI (or input current) for the voltage conversion circuit 100.

According to the above-described configurations, the voltage converter 10 may maintain the input voltage VI for the voltage conversion circuit 100 to improve the efficiency of the voltage conversion operation through the voltage conversion circuit 100.

For example, the switch controller 110 may also perform a third operation of turning on a portion of the plurality of switches such that the voltage conversion circuit 100 outputs the charging current IO from a second input voltage having a voltage value of a second integer multiple (for example, 4 times) of the charging voltage VO.

For example, the switch controller 110 may also perform a fourth operation of turning on a portion of the plurality of switches such that the voltage conversion circuit 100 outputs the charging current IO from the second input voltage.

The switch controller 110 may repeatedly and alternately perform the third operation and the fourth operation at the same interval.

For example, the switch controller 110 may also perform a fifth operation of turning on a portion of the plurality of switches such that the voltage conversion circuit 100 outputs the charging current IO from a third input voltage having a voltage value of a third integer multiple (for example, 2 times) of the charging voltage VO.

For example, the switch controller 110 may also perform a sixth operation of turning on a portion of the plurality of switches such that the voltage conversion circuit 100 outputs the charging current IO from the third input voltage.

The switch controller 110 may repeatedly and alternately perform the fifth operation and the sixth operation at the same interval.

Referring to the above-described configurations, the voltage converter 10 according to some example embodiments may output the charging current IO corresponding to the charging voltage VO from different input voltages, each having a voltage value that is a multiple of the charging voltage VO.

For example, the voltage converter 10 may convert each of the plurality of different input voltages into the charging voltage VO by controlling the single voltage conversion circuit 100. Furthermore, the voltage converter 10 may output the charging current IO based on the charging voltage VO.

Accordingly, the voltage converter 10 may be implemented with a relatively small area compared to the case of including a plurality of conversion circuits for converting each of a plurality of different input voltages into the charging voltage VO.

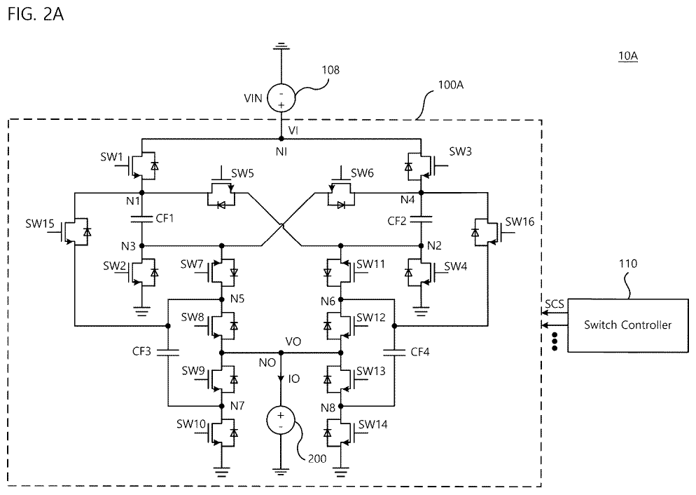

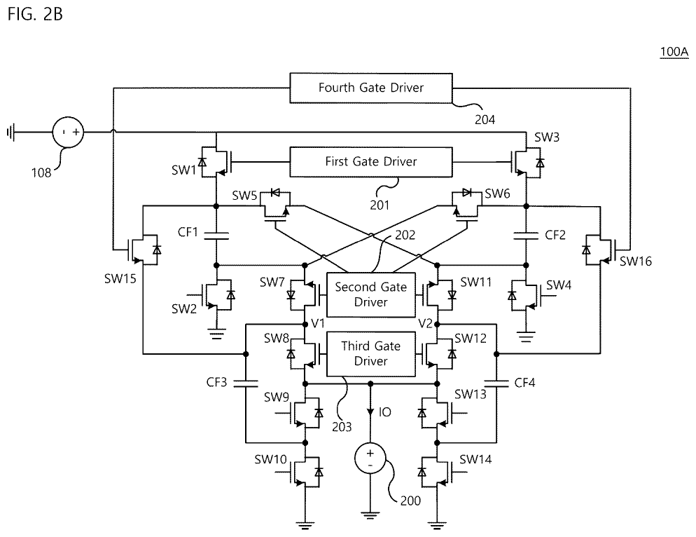

FIG. 2A is a circuit diagram of a voltage converter according to some example embodiments, and FIG. 2B is a circuit diagram of a voltage conversion circuit including a first gate driver to a fourth gate driver according to some example embodiments.

Referring to FIG. 2A and FIG. 2B, a voltage converter 10A according to some example embodiments may include a voltage conversion circuit 100A and a switch controller 110.

Also, the voltage conversion circuit 100A may include a plurality of switches SW1 to SW16 and a plurality of floating capacitors CF1 to CF4 connected to the plurality of switches SW1 to SW16.

The voltage converter 10A and the voltage conversion circuit 100A illustrated in FIG. 2A and FIG. 2B may be understood as an example of the voltage converter 10 and the voltage conversion circuit 100 illustrated in FIG. 1, respectively. Therefore, the same or substantially the same components are represented by the same reference numerals, and redundant descriptions will be omitted to avoid repetition.

According to some example embodiments, each of the plurality of switches SW1 to SW16 may be implemented through at least a portion of a transistor and a diode, but example embodiments are not limited thereto.

The voltage conversion circuit 100A may include a first floating capacitor CF1 and a second floating capacitor CF2. For example, the voltage conversion circuit 100A may include the first floating capacitor CF1 and the second floating capacitor CF2 electrically connected to each other through at least one switch (for example, the fifth switch SW5 and the sixth switch SW6).

Also, the voltage conversion circuit 100A may include a first switch SW1 and a second switch SW2, both connected to the first floating capacitor CF1.

For example, the voltage conversion circuit 100A may include the first switch SW1 connected between a voltage source 108 (or an input node N1) and the first floating capacitor CF1. Also, the voltage conversion circuit 100A may include the second switch SW2 connected between the first floating capacitor CF1 and ground.

Also, the voltage conversion circuit 100A may include a third switch SW3 and a fourth switch SW4, both connected to the second floating capacitor CF2.

For example, the voltage conversion circuit 100A may include a third switch SW3 connected between the voltage source 108 or the input node N1 and the second floating capacitor CF2. Also, the voltage conversion circuit 100A may include a fourth switch SW4 connected between the second floating capacitor CF2 and ground.

Also, the voltage conversion circuit 100A may include a fifth switch SW5 connected between a first node N1 between the first switch SW1 and the first floating capacitor CF1 and a second node N2 between the second floating capacitor CF2 and the fourth switch SW4.

Also, the voltage conversion circuit 100A may include a sixth switch SW6 connected between a third node N3 between the first floating capacitor CF1 and the second switch SW2 and a fourth node N4 between the third switch SW3 and the second floating capacitor CF2.

The voltage conversion circuit 100A may include seventh to tenth switches SW7 to SW10 connected in series between the third node N3 and the ground. A source electrode of the sixth switch SW6 may be connected to a source electrode of the seventh switch SW7 through the third node N3.

Also, the voltage conversion circuit 100A may include eleventh to fourteenth switches SW11 to SW14 connected in series between the second node N2 and the ground. A source electrode of the fifth switch SW5 may be connected to a source electrode of the eleventh switch SW11 through the second node N2.

The voltage conversion circuit 100A may include a fifteenth switch SW15 connected between the first node N1 and a fifth node N5 between the seventh switch SW7 and the eighth switch SW8.

Also, the voltage conversion circuit 100A may include a sixteenth switch SW16 connected between the fourth node N4 and a sixth node N6 between the eleventh switch SW11 and the twelfth switch SW12.

Also, the voltage conversion circuit 100A may include a third floating capacitor CF3 and a fourth floating capacitor CF4, each connected to the output node NO.

For example, the third floating capacitor CF3 may be connected between the fifth node N5 and a seventh node N7 between the ninth switch SW9 and the tenth switch SW10.

Also, the fourth floating capacitor CF4 may be connected between the sixth node N6 and an eighth node N8 between the thirteenth switch SW13 and the fourteenth switch SW14.

The voltage conversion circuit 100A may output the charging current IO through an output node NO, commonly connected between the eighth switch SW8 and the ninth switch SW9 and between the twelfth switch SW12 and the thirteenth switch SW13.

The charging current IO may be understood as a current applied to charge a power device 200 connected to the output node NO.

For example, the power device 200 may be referred to as an electronic device, system, or battery connected to the voltage converter 10A, but example embodiments are not limited thereto. For example, the power device 200 may be referred to as a battery of an electronic device or system including the voltage converter 10A.

Referring to the above-described configurations, the voltage conversion circuit 100A may output the charging current IO through the output node NO based on the input voltage VI applied from the voltage source 108.

For example, the voltage conversion circuit 100A may convert the input voltage VI, applied from the voltage source 108, into the charging voltage VO based on a specified ratio. For example, when the input voltage VI applied from the voltage source 108 has a value of 3 times the charging voltage VO, the voltage conversion circuit 100A may convert the input voltage VI into the charging voltage VO based on a ratio of 3:1.

The switch controller 110 may control at least a portion of the plurality of switches SW1 to SW16 through at least one switch control signal SCS to convert the input voltage VI into the charging voltage VO.

Referring to FIG. 2B, the voltage converter 10A according to some example embodiments may further include a first gate driver 201, a second gate driver 202, a third gate driver 203, and a fourth gate driver 204.

According to some example embodiments, the voltage conversion circuit 100A may include the first gate driver 201 connected to a gate electrode of the first switch SW1 and a gate electrode of the third switch SW3.

Also, the voltage conversion circuit 100A may include the second gate driver 202 connected to a gate electrode of each of the fifth switch SW5, the sixth switch SW6, the seventh switch SW7, and the eleventh switch SW11.

Also, the voltage conversion circuit 100A may include the third gate driver 203 connected to a gate electrode of the eighth switch SW8 and a gate electrode of the twelfth switch SW12.

Also, the voltage conversion circuit 100A may include the fourth gate driver 204 connected to a gate electrode of the fifteenth switch SW15 and a gate electrode of the sixteenth switch SW16.

Each of the first gate driver 201, the second gate driver 202, the third gate driver 203, and the fourth gate driver 204 may be understood as a circuit applying a gate voltage to the connected switch to drive the switch.

For example, the first gate driver 201 may be understood as a circuit applying a gate voltage to the gate electrode of the first switch SW1 to drive the first switch SW1 under the control of the switch controller 110.

Also, each of the first gate driver 201, the second gate driver 202, the third gate driver 203, and the fourth gate driver 204 may be understood as a circuit applying a voltage for operating a corresponding transistor to a gate electrode based on a voltage applied to a source electrode for a connected transistor.

For example, the switch controller 110 may control the first gate driver 201, the second gate driver 202, the third gate driver 203, and the fourth gate driver 204 through at least one switch control signal SCS.

The switch controller 110 may turn on or turn off at least a portion of the plurality of switches SW1 to SW16 through the first gate driver 201, the second gate driver 202, the third gate driver 203, and the fourth gate driver 204.

Thus, the voltage converter 10A may output the charging current IO through the output node NO from the input voltage VI having a specified ratio with the charging voltage VO.

According to some example embodiments, the switch controller 110 may alternately and repeatedly perform operations of turning on different switches, among the plurality of switches SW1 to SW16, such that the voltage conversion circuit 100A outputs the charging current IO.

For example, the switch controller 110 may alternately and repeatedly perform operations of turning on different switches, among the plurality of switches SW1 to SW16, to control the electrical connection of each of the plurality of floating capacitors CF1 to CF4.

Thus, the voltage converter 10A according to some example embodiments may maintain a constant input voltage VI or input current for the voltage conversion circuit 100A.

Furthermore, the voltage converter 10A may maintain the input voltage VI for the voltage conversion circuit 100A to improve the efficiency of a voltage conversion operation through the voltage conversion circuit 100A.

According to some example embodiments, the sixth switch SW6 and the seventh switch SW7 may share a source electrode through the third node N3. Also, the fifth switch SW5 and the eleventh switch SW11 may share a source electrode through the second node N2.

Thus, the voltage converter 10A according to some example embodiments may reduce an area required to implement a plurality of switches (for example, SW5, SW6, SW7, and SW11) implemented as transistors in the voltage conversion circuit 100A.

As a result, the voltage converter 10A according to some example embodiments may reduce an area of the voltage conversion circuit 100A converting the input voltage VI to output the charging current IO.

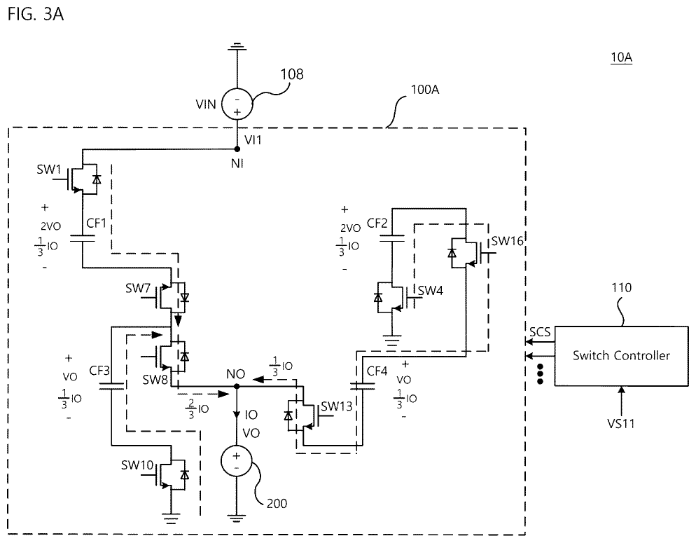

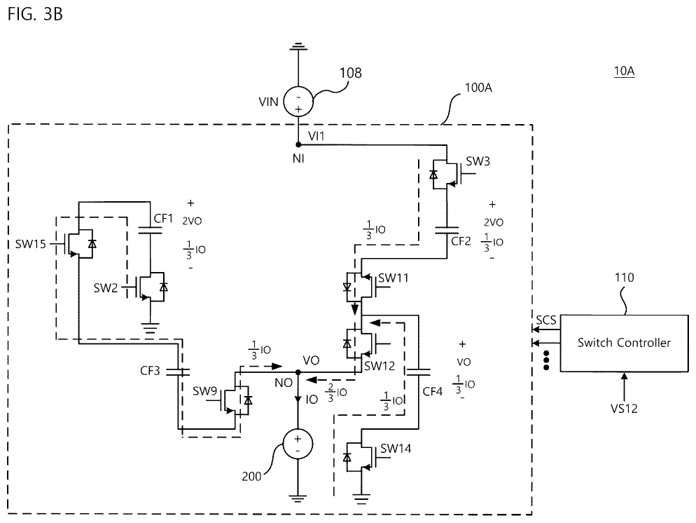

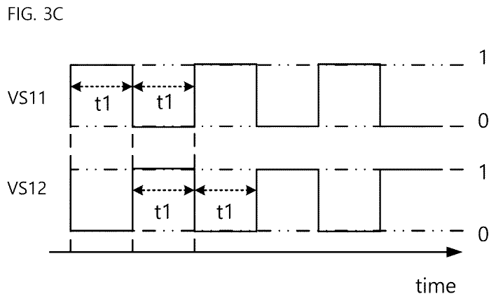

FIG. 3A is a circuit diagram illustrating a flow of current in a voltage conversion circuit while a switch controller performs a first operation according to some example embodiments. FIG. 3B is a circuit diagram illustrating a flow of current in the voltage conversion circuit while the switch controller performs a second operation according to some example embodiments. FIG. 3C is a diagram illustrating voltage control signals controlling the switch controller to perform the first operation and the second operation according to some example embodiments.

Referring to FIG. 3A and FIG. 3B, the switch controller 110 according to some example embodiments may control at least a portion of the plurality of switches SW1 to SW16 included in the voltage conversion circuit 100A. Thus, the voltage conversion circuit 100A may output the charging current IO based on the first input voltage VI1.

The switch controller 110 according to some example embodiments may perform a first operation and a second operation of controlling at least a portion of the plurality of switches SW1 to SW16 included in the voltage conversion circuit 100A.

For example, when the voltage source 108 generates the first input voltage VI1, the switch controller 110 may perform the first operation and the second operation of controlling at least a portion of the plurality of switches SW1 to SW16 in response to first voltage control signals VS11 and VS12.

Referring to FIG. 3A and FIG. 3C, the switch controller 110 may perform a first operation of controlling at least a portion of the plurality of switches SW1 to SW16 such that the voltage conversion circuit 100A outputs the charging current IO in response to the (1-1)-th operation signal VS11.

For example, in the first operation, the switch controller 110 may turn on the first switch SW1 to connect the first floating capacitor CF1 to the voltage source 108 (or the input node N1).

In the first operation, the switch controller 110 may also turn on the tenth switch SW10 to connect the third floating capacitor CF3 to the ground.

In the first operation, the switch controller 110 may also turn on the seventh switch SW7 and the eighth switch SW8 such that a current ⅓*IO flowing through the first floating capacitor CF1 and a current ⅓*IO flowing through the third floating capacitor CF3 flow to the output node NO. Herein, the “*” symbol may refer to a multiplication time, for example, ⅓*IO is the equivalent of one third of the charging current IO.

For example, the current ⅓*IO flowing through the first floating capacitor CF1 and the current ⅓*IO flowing through the third floating capacitor CF3 may be summed to result in a current ⅔*IO, having a current value corresponding to ⅔ of the charging current IO, flowing to the output node NO.

In the first operation, the switch controller 110 may also turn on the fourth switch SW4, the thirteenth switch SW13, and the sixteenth switch SW16 to connect the second floating capacitor CF2 and the fourth floating capacitor CF4 in series between the ground and the output node NO.

For example, a current ⅓*IO having a current value corresponding to ⅓ of the charging current IO may flow to the output node NO through the second floating capacitor CF2 and the fourth floating capacitor CF4.

For example, the switch controller 110 may perform a first operation of connecting the first floating capacitor CF1 to the voltage source 108, connecting the third floating capacitor CF3 to the ground, and connecting the second floating capacitor CF2 and the fourth floating capacitor CF4 in series between the ground and the output node NO in response to a (1-1)-th operation signal VS11.

In the first operation, the switch controller 110 may turn off the second switch SW2, the third switch SW3, the fifth switch SW5, the sixth switch SW6, the ninth switch SW9, the eleventh switch SW11, the twelfth switch SW12, the fourteenth switch SW14, and the fifteenth switch SW15.

Referring to FIG. 3B and FIG. 3C, the switch controller 110 may perform a second operation of controlling at least a portion of the plurality of switches SW1 to SW16 such that the voltage conversion circuit 100A outputs the charging current IO in response to a (1-2)-th operation signal VS12.

For example, in the second operation, the switch controller 110 may turn on the third switch SW3 to connect the second floating capacitor CF2 to the voltage source 108 (or the input node N1).

In the second operation, the switch controller 110 may also turn on the fourteenth switch SW14 to connect the fourth floating capacitor CF4 to the ground.

In the second operation, the switch controller 110 may also turn on the eleventh switch SW11 and the twelfth switch SW12 such that the current ⅓*IO flowing through the second floating capacitor CF2 and the current ⅓*IO flowing through the fourth floating capacitor CF4 flow to the output node NO.

In the second operation, the switch controller 110 may also turn on the second switch SW2, the ninth switch SW9, and the fifteenth switch SW15 to connect the first floating capacitor CF1 and the third floating capacitor CF3 in series between the ground and the output node NO.

For example, a current ⅓*IO having a current value corresponding to ⅓ of the charging current IO may flow to the output node NO through the first floating capacitor CF1 and the third floating capacitor CF3.

For example, the switch controller 110 may perform the second operation of connecting the second floating capacitor CF2 to the voltage source 108, connecting the fourth floating capacitor CF4 to the ground, and connecting the first floating capacitor CF1 and the third floating capacitor CF3 in series between the ground and the output node NO in response to the (1-2)-th operation signal VS12.

In the second operation, the switch controller 110 may also turn off the first switch SW1, the fourth switch SW4, the fifth switch SW5, the sixth switch SW6, the seventh switch SW7, the eighth switch SW8, the tenth switch SW10, the thirteenth switch SW13, and the sixteenth switch SW16.

According to some example embodiments, the switch controller 110 may alternately perform the first operation and the second operation using the (1-1)-th operation signal VS11 and the (1-2)-th operation signal VS12, respectively.

For example, referring to FIG. 3C, the switch controller 110 may alternately perform the first operation and the second operation using the (1-1)-th operation signal VS11 and the (1-2)-th operation signal VS12 having a predetermined (or, alternative, determined or desired) duty ratio, respectively.

For example, each of the (1-1)-th operation signal VS11 and the (1-2)-th operation signal VS12 may have a duty ratio of 50%. Therefore, each of the (1-1)-th operation signal VS11 and the (1-2)-th operation signal VS12 may be alternately maintained at “1” and “0” for the same time t1.

The (1-1)-th operation signal VS11 and the (1-2)-th operation signal VS12 may have opposite phrases. For example, while the (1-1)-th operation signal VS11 has a value of “1,” the (1-2)-th operation signal VS12 may have a value of “0.”

For example, the switch controller 110 may perform the first operation using the (1-1)-th operation signal VS11 having a duty ratio of 50%. Also, the switch controller 110 may perform the second operation using the (1-2)-th operation signal VS12 having a duty ratio of 50%.

Accordingly, the switch controller 110 may alternately perform the first operation and the second operation at the same time interval using the (1-1)-th operation signal VS11 and the (1-2)-th operation signal VS12 having the same duty ratio.

Referring to FIGS. 3A to 3C, when the switch controller 110 alternately performs the first operation and the second operation, a voltage value of twice the charging voltage VO (for example, 2*VO) may be maintained in the first floating capacitor CF1 and the second floating capacitor CF2. Also, a voltage equal to the charging voltage VO may be maintained in the third floating capacitor CF3 and the fourth floating capacitor CF4.

The voltage source 108 may output a first input voltage VI1 having a voltage value of 3 times the charging voltage VO (for example, 3*VO).

For example, the switch controller 110 may control at least a portion of the plurality of switches SW1 to SW16 included in the voltage conversion circuit 100A such that the voltage conversion circuit 100A outputs the charging current IO from the first input voltage VI1 having a voltage value of 3 times the charging voltage VO.

Accordingly, as the first input voltage VI1 that is 3 times the charging voltage VO is applied to the voltage conversion circuit 100A from the voltage source 108, the voltage converter 10A may operate as a 3:1 voltage converter outputting the charging current IO.

Referring to the above-described configurations, the voltage converter 10A may reduce the number of switches and capacitors for implementing the voltage conversion circuit 100A. Thus, the voltage converter 10A according to some example embodiments may reduce an area of the voltage conversion circuit 100A.

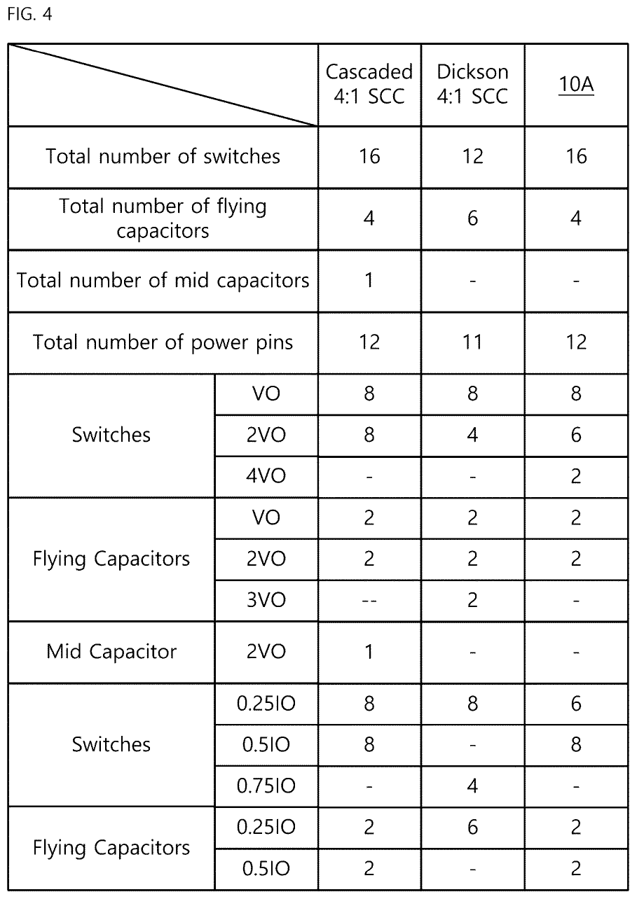

FIG. 4 is a table illustrating the types and numbers of elements included in each of a voltage converter according to comparative examples and a voltage converter according to some example embodiments.

Referring to FIG. 4, the voltage converter 10A according to some example embodiments may be implemented with a relatively small number of elements compared to a voltage converter according to comparative examples.

For example, the voltage converter 10A according to some example embodiments may be implemented with a relatively small number of switches and/or capacitors compared to the voltage converter according to comparative examples. For example, the voltage converter 10A according to some example embodiments may be implemented to include 16 switches, 4 capacitors, and 12 power pins.

For example, the voltage converter 10A according to some example embodiments may be implemented by omitting a mid capacitor, compared to a Cascaded 4:1 SCC according to comparative examples.

For example, the voltage converter 10A according to some example embodiments may be implemented with a relatively small number of 4 floating capacitors compared to a Dickson 4:1 SCC, according to comparative examples, implemented with 6 floating capacitors.

Also, the voltage converter 10A according to some example embodiments may include a relatively small number of 6 switches compared to a Cascaded 4:1 SCC, according to comparative examples, including 8 switches each having a voltage value of twice the charging voltage VO.

Referring to the above-described configuration, the voltage converter 10A according to some example embodiments may be implemented through a relatively small number and types of elements compared to a voltage converter according to comparative examples.

Thus, the voltage conversion circuit 100A according to some example embodiments may have a relatively small area compared to a voltage converter according to comparative examples.

Also, the voltage conversion circuit 100A according to some example embodiments may include a relatively small number of 6 switches with a current stress of 0.25IO, compared to a Cascaded 4:1 SCC, according to comparative examples, including 8 switches with a current stress of 0.25IO maintained.

Also, the voltage conversion circuit 100A according to some example embodiments may not include switches with a current stress of 0.75IO, compared to a Dickson 4:1 SCC, according to comparative examples, including 4 switches with a current stress of 0.75IO maintained.

Referring to the above-described configurations, the voltage converter 10A according to some example embodiments may include relatively fewer elements with high current stress e.g., 0.75IO or 0.5IO maintained compared to a voltage converter according to comparative examples. For example, according to some example embodiments, there may be an improvement in a size of the device, device layout, accuracy, and/or power efficiency of the voltage converter based on the above methods. Therefore, the improved devices and methods overcome the deficiencies of the conventional devices and methods while reducing resource consumption, and/or improving device size, operating parameters, and resource allocation (e.g., latency).

Thus, the voltage converter 10A according to some example embodiments may reduce loss caused by current stress applied to the switches.

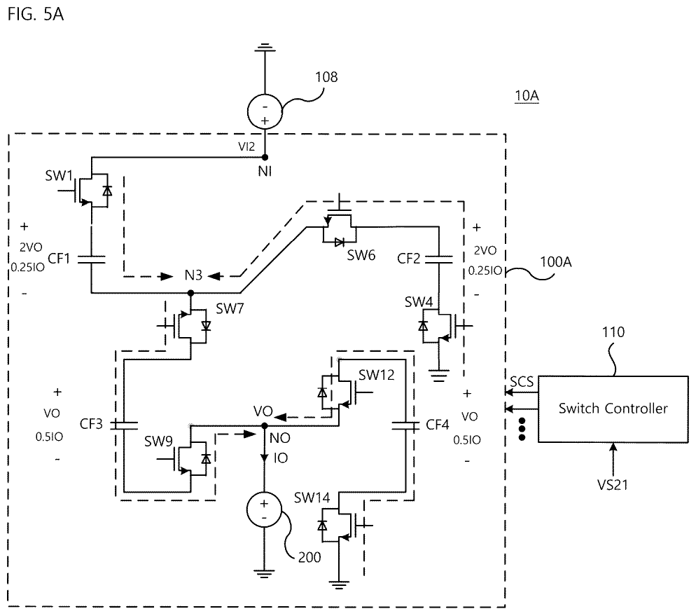

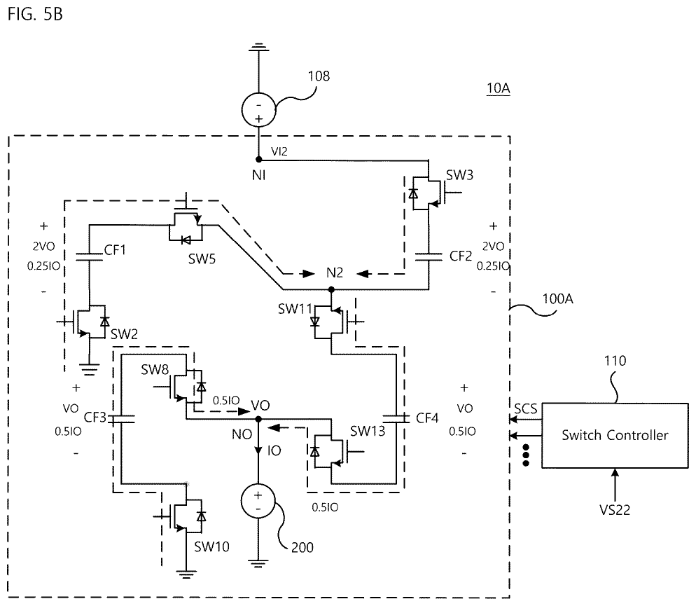

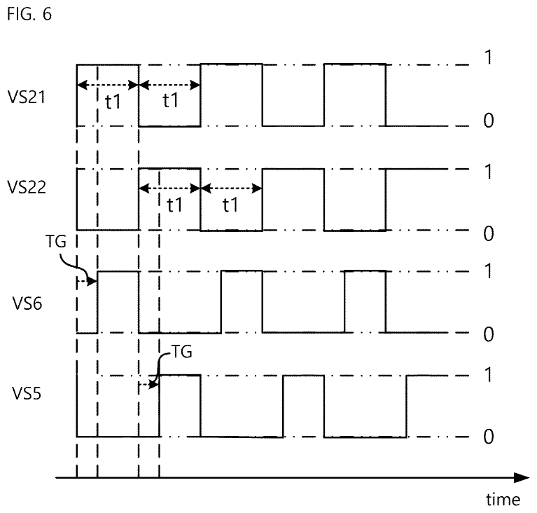

FIG. 5A is a circuit diagram illustrating a flow of current in the voltage conversion circuit while the switch controller performs a third operation according to some example embodiments, and FIG. 5B is a circuit diagram illustrating a flow of current in the voltage conversion circuit while the switch controller performs a fourth operation according to some example embodiments. FIG. 6 is a diagram illustrating voltage control signals controlling the switch controller to perform the third operation and the fourth operation, and signals controlling each of a fifth switch and a sixth switch according to some example embodiments.

Referring to FIGS. 5A and 5B and FIG. 6, the switch controller 110 according to some example embodiments may control at least a portion of the plurality of switches SW1 to SW16 included in the voltage conversion circuit 100A. Thus, the voltage conversion circuit 100A may output the charging current IO based on the second input voltage VI2.

The second input voltage VI2 may be understood to have a value of 4 times the charging voltage VO.

For example, the switch controller 110 may perform a third operation and a fourth operation of controlling at least a portion of the plurality of switches SW1 to SW16 included in the voltage conversion circuit 100A.

Referring to FIG. 5A, the switch controller 110 according to some example embodiments may perform a third operation of controlling at least a portion of the plurality of switches SW1 to SW16 such that the voltage conversion circuit 100A outputs the charging current IO based on a (2-1)-th operation signal VS21.

For example, in the third operation, the switch controller 110 may turn on the first switch SW1 to connect the first floating capacitor CF1 to a voltage source 108 (or an input node N1).

In the third operation, the switch controller 110 may also turn on the seventh switch SW7 and the sixth switch SW6 to connect the third floating capacitor CF3 to a first floating capacitor CF1 and a second floating capacitor CF2.

In the third operation, the switch controller 110 may also turn on the fourth switch SW4 and the fourteenth switch SW14 to connect the second floating capacitor CF2 and a fourth floating capacitor CF4 to ground.

For example, the switch controller 110 may perform the third operation of connecting the first floating capacitor CF1 to the voltage source 108, connecting the third floating capacitor CF3 to the first floating capacitor CF1 and the second floating capacitor CF2, and connecting the second floating capacitor CF2 and the fourth floating capacitor CF4 to the ground.

In the third operation, the switch controller 110 may turn off the second switch SW2, the third switch SW3, the fifth switch SW5, the eighth switch SW8, the tenth switch SW10, the eleventh switch SW11, the thirteenth switch SW13, the fifteenth switch SW15, and the sixteenth switch SW16.

Referring to FIG. 5B, the switch controller 110 according to some example embodiments may perform a fourth operation of controlling at least a portion of the plurality of switches SW1 to SW16 such that the voltage conversion circuit 100A outputs the charging current IO based on a (2-2)-th operation signal VS22.

For example, in the fourth operation, the switch controller 110 may turn on the third switch SW3 to connect the second floating capacitor CF2 to the voltage source 108 or the input node N1.

In the fourth operation, the switch controller 110 may also turn on the eleventh switch SW11 and the fifth switch SW5 to connect the fourth floating capacitor CF4 to the first floating capacitor CF1 and the second floating capacitor CF2.

In the fourth operation, the switch controller 110 may also turn on the second switch SW2 and the tenth switch SW10 to connect the first floating capacitor CF1 and the third floating capacitor CF3 to ground.

For example, the switch controller 110 may perform the fourth operation of connecting the second floating capacitor CF2 to the voltage source 108, connecting the fourth floating capacitor CF4 to the first floating capacitor CF1 and the second floating capacitor CF2, and connecting the first floating capacitor CF1 and the third floating capacitor CF3 to the ground.

In the fourth operation, the switch controller 110 may turn off the first switch SW1, the fourth switch SW4, the sixth switch SW6, the seventh switch SW7, the ninth switch SW9, the twelfth switch SW12, the fourteenth switch SW14, the fifteenth switch SW15, and the sixteenth switch SW16.

According to some example embodiments, the switch controller 110 may alternately perform the third operation and the fourth operation using the (2-1)-th operation signal VS21 and the (2-2)-th operation signal VS22, respectively.

For example, referring to FIG. 6, the switch controller 110 may alternately perform the third operation and the fourth operation using the (2-1)-th operation signal VS21 and the (2-2)-th operation signal VS22 having a predetermined (or, alternative, determined or desired) duty ratio, respectively.

For example, each of the (2-1)-th operation signal VS21 and the (2-2)-th operation signal VS22 may have a duty ratio of 50%. Therefore, each of the (2-1)-th operation signal VS21 and the (2-2)-th operation signal VS22 may be alternately maintained at “1” and “0” for the same time t1.

Also, the (2-1)-th operation signal VS21 and the (2-2)-th operation signal VS22 may have opposite phrases. For example, while the (2-1)-th operation signal VS21 has a value of “1,” the (2-2)-th operation signal VS22 may have a value of “0.”

For example, the switch controller 110 may perform the third operation using the (2-1)-th operation signal VS21 having a duty ratio of 50%. Also, the switch controller 110 may perform the fourth operation using the (2-2)-th operation signal VS22 having a duty ratio of 50%.

Accordingly, the switch controller 110 may alternately perform the third operation and the fourth operation at the same time interval using the (2-1)-th operation signal VS21 and the (2-2)-th operation signal VS22 having the same duty ratio.

Referring to FIG. 5A to FIG. 6, when the switch controller 110 alternately performs the third operation and the fourth operation, a voltage having a voltage value of twice the charging voltage VO (for example, 2*VO) may be maintained in the first floating capacitor CF1 and the second floating capacitor CF2.

The voltage source 108 may output a second input voltage VI2 having a voltage value of 4 times the charging voltage VO (for example, 4*VO).

A current (for example, 0.2510), smaller than the charging current IO, may flow through each of the first floating capacitor CF1 and the second floating capacitor CF2.

When the switch controller 110 performs the third operation according to some example embodiments, the currents (for example, 0.25IO) flowing through each of the first floating capacitor CF1 and the second floating capacitor CF2 may be summed at the third node N3 and then transferred to the third floating capacitor CF3 through the seventh switch SW7.

When the switch controller 110 performs the fourth operation according to some example embodiments, the currents (for example, 0.25IO) flowing through each of the first floating capacitor CF1 and the second floating capacitor CF2 may be summed at the second node N2 and then transferred to the fourth floating capacitor CF4 through the eleventh switch SW11.

Also, when the switch controller 110 alternately performs the third operation and the fourth operation, a voltage equal to the charging voltage VO may be maintained in the third floating capacitor CF3 and the fourth floating capacitor CF4.

Accordingly, a current (for example, 0.510) smaller than the charging current IO may flow through the third floating capacitor CF3 and the fourth floating capacitor CF4.

In addition, the currents (for example, 0.510) applied to the third floating capacitor CF3 and the fourth floating capacitor CF4 may be summed through the output node NO and then output as the charging current IO.

For example, the switch controller 110 may control at least a portion of the plurality of switches SW1 to SW16 included in the voltage conversion circuit 100A such that the voltage conversion circuit 100A outputs the charging current IO from the second input voltage VI2 having a voltage value of 4 times the charging voltage VO.

Accordingly, as the second input voltage VI2 that is 4 times the charging voltage VO is applied to the voltage conversion circuit 100A from the voltage source 108, the voltage converter 10A may operate as a 4:1 voltage converter outputting the charging current IO.

Referring to FIGS. 3A to 3C and FIG. 5A to FIG. 6, the voltage converter 10A may convert each of a plurality of different input voltages (for example, the first input voltage VI1 and the second input voltage VI2) into the charging voltage VO by controlling the single voltage conversion circuit 100. In addition, the voltage converter 10 may output the charging current IO based on the charging voltage VO.

The second input voltage VI2 may have a larger value than the first input voltage VI1.

For example, the voltage converter 10A may operate as a 3:1 voltage converter or a 4:1 voltage converter under the control of the switch controller 110.

Thus, the voltage converter 10A according to some example embodiments may be implemented with a relatively small area compared to the case of including a plurality of conversion circuits converting each of a plurality of different input voltages into the charging voltage VO.

Referring to FIG. 5A and FIG. 6, the switch controller 110 according to some example embodiments may control the sixth switch SW6 in the third operation in response to the sixth switch signal VS6, distinguished from the (2-1)-th operation signal VS21.

For example, in the third operation, the switch controller 110 may turn on the first switch SW1, the fourth switch SW4, the seventh switch SW7, the ninth switch SW9, the twelfth switch SW12, and the fourteenth switch SW14 in response to the high-level (2-1)-th operation signal VS21.

Also, the switch controller 110 may turn on the sixth switch SW6 in response to the high-level sixth switch signal VS6.

A rising edge of the sixth switch signal VS6 may occur after a specified time interval TG from the time at which a rising edge of the (2-1)-th operation signal VS21 occurs.

For example, the switch controller 110 may turn on the sixth switch SW6 after a specified time interval TG from the time at which the first switch SW1 is turned on.

According to some example embodiments, charge may be stored in the first floating capacitor CF1 by the second input voltage VI2 during the specified time interval TG from at the moment the first switch SW1 is turned on. As charges are stored in the first floating capacitor CF1, a voltage applied to the third node N3 may increase.

Accordingly, when the sixth switch SW6 is turned on after the specified time interval TG from the time at which the first switch SW1 is turned on, the voltage stress applied to the sixth switch SW6 may be reduced by a voltage at a third node N3, which has increased over the specified time interval TG, from four times the charging voltage VO (4*VO).

For example, the sixth switch SW6 may be turned on after a specified time interval TG from the time at which the first switch SW1 is turned on, thereby reducing an on-breakdown voltage ON BV applied to the sixth switch SW6.

Referring to FIG. 5B and FIG. 6, in the fourth operation, the switch controller 110 according to some example embodiments may control the fifth switch SW5 in response to the fifth switch signal VS5, distinguished from the (2-2)-th operation signal VS22.

For example, in the fourth operation, the switch controller 110 may turn on the second switch SW2, the third switch SW3, the eighth switch SW8, the tenth switch SW10, the eleventh switch SW11, and the thirteenth switch SW13 in response to the high-level (2-2)-th operation signal VS22.

Also, the switch controller 110 may turn on the fifth switch SW5 in response to the high-level fifth switch signal VS5.

A rising edge of the fifth switch signal VS5 may occur after a specified time interval TG from the time at which the rising edge of the (2-2)-th operation signal VS22 occurs.

For example, the switch controller 110 may turn on the fifth switch SW5 after a specified time interval TG from the time at which the third switch SW3 is turned on.

According to some example embodiments, charges may be stored in the second floating capacitor CF2 by the second input voltage VI2 applied from the voltage source 108 during the specified time interval TG from the moment the third switch SW3 is turned on. As the charges are stored in the second floating capacitor CF2, the voltage applied to the second node N2 may increase.

Accordingly, when the fifth switch SW5 is turned on after the specified time interval TG from the time at which the third switch SW3 is turned on, the voltage stress applied to the fifth switch SW5 may be reduced from 4 times the value of the charging voltage (4*VO) by the voltage of the second node N2 increased during the specified time interval TG.

For example, the fifth switch SW5 may be turned on after the specified time interval TG from the time at which the third switch SW3 is turned on, thereby reducing an on-breakdown voltage ON BV applied to the fifth switch SW5.

Referring to the above-described configurations, in the third operation, the switch controller 110 according to some example embodiments may turn on the sixth switch SW6 after a certain time from the time when the first switch SW1 is turned on. In the fourth operation, the switch controller 110 may also turn on the fifth switch SW5 after a certain time from the time at which the third switch SW3 is turned on.

Thus, the switch controller 110 according to some example embodiments may reduce the on-breakdown voltage ON BV applied to the fifth switch SW5 and the sixth switch SW6.

According to the above-described configurations, the voltage converter 10A (or the voltage conversion circuit 100A) may be configured with switches having a relatively low on-breakdown voltage ON BV.

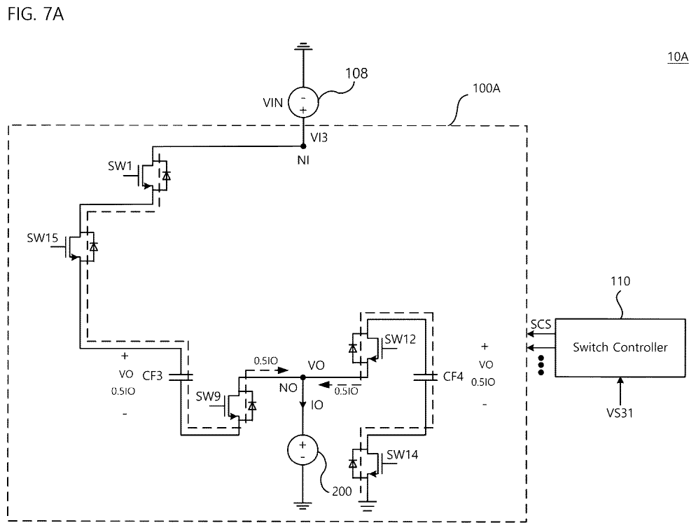

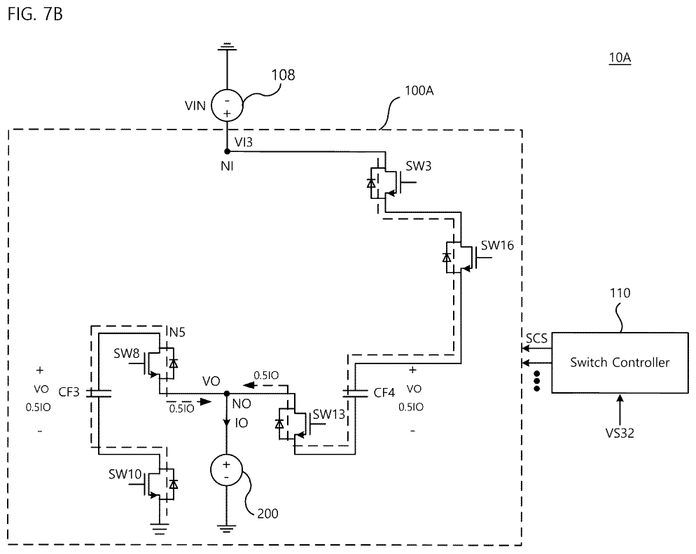

FIG. 7A is a circuit diagram illustrating a flow of current in the voltage conversion circuit while the switch controller performs a fifth operation according to some example embodiments. FIG. 7B is a circuit diagram illustrating a flow of current in the voltage conversion circuit while the switch controller performs a sixth operation according to some example embodiments.

Referring to FIG. 7A and FIG. 7B, the switch controller 110 according to some example embodiments may control at least a portion of the plurality of switches SW1 to SW16 included in the voltage conversion circuit 100A. Thus, the voltage conversion circuit 100A may output a charging current IO based on a third input voltage VI3.

The third input voltage VI3 may be understood to have a value of 2 times the charging voltage VO.

For example, the switch controller 110 may perform a fifth operation and a sixth operation of controlling at least a portion of the plurality of switches SW1 to SW16 included in the voltage conversion circuit 100A.

Referring to FIG. 7A, the switch controller 110 according to some example embodiments may perform a fifth operation of controlling at least a portion of the plurality of switches SW1 to SW16 such that the voltage conversion circuit 100A outputs the charging current IO based on the third-1 operation signal VS31.

For example, in the fifth operation, the switch controller 110 may turn on the first switch SW1 and the fifteenth switch SW15 to connect the third floating capacitor CF3 to the voltage source 108 or the input node N1.

In the fifth operation, the switch controller 110 may also turn on the fourteenth switch SW14 to connect the fourth floating capacitor CF4 to the ground.

In the fifth operation, the switch controller 110 may also turn on the ninth switch SW9 and the twelfth switch SW12 to connect the third floating capacitor CF3 and the fourth floating capacitor CF4 to the output node NO.

For example, the switch controller 110 may perform the fifth operation of connecting the third floating capacitor CF3 to the voltage source 108 and the output node NO, and connecting the fourth floating capacitor CF4 to the ground and the output node NO.

In the fifth operation, the switch controller 110 may turn off the second switch SW2, the third switch SW3, the fourth switch SW4, the fifth switch SW5, the seventh switch SW7, the eighth switch SW8, the tenth switch SW10, the eleventh switch SW11, the thirteenth switch SW13, and the sixteenth switch SW16.

Referring to FIG. 7B, the switch controller 110 according to some example embodiments may perform a sixth operation of controlling at least a portion of the plurality of switches SW1 to SW16 such that the voltage conversion circuit 100A outputs the charging current IO based on the third-2 operation signal VS32.

For example, in the sixth operation, the switch controller 110 may turn on the third switch SW3 and the sixteenth switch SW16 to connect the fourth floating capacitor CF4 to the voltage source 108 or the input node N1.

In the sixth operation, the switch controller 110 may also turn on the tenth switch SW10 to connect the third floating capacitor CF3 to the ground.

In the sixth operation, the switch controller 110 may also turn on the eighth switch SW8 and the thirteenth switch SW13 to connect the third floating capacitor CF3 and the fourth floating capacitor CF4 to the output node NO.

For example, the switch controller 110 may perform the sixth operation of connecting the third floating capacitor CF3 to the ground and the output node NO, and connecting the fourth floating capacitor CF4 to the voltage source 108 and the output node NO.

In the sixth operation, the switch controller 110 may also turn off the first switch SW1, the second switch SW2, the fourth switch SW4, the fifth switch SW5, the sixth switch SW6, the seventh switch SW7, the ninth switch SW9, the eleventh switch SW11, the twelfth switch SW12, the fourteenth switch SW14, and the fifteenth switch SW15.

According to some example embodiments, the switch controller 110 may alternately perform the fifth operation and the sixth operation using a (3-1)-th operation signal VS31 and a (3-2)-th operation signal VS32, respectively.

For example, the switch controller 110 may alternately perform the fifth operation and the sixth operation using the (3-1)-th operation signal VS31 and the (3-2)-th operation signal VS32 having a predetermined (or, alternative, determined or desired) duty ratio, respectively.

For example, each of the (3-1)-th operation signal VS31 and the (3-2)-th operation signal VS32 may have a duty ratio of 50%. Therefore, each of the (3-1)-th operation signal VS31 and the (3-2)-th operation signal VS32 may be alternately maintained at “1” and “0” for the same time t1.

In addition, the (3-1)-th operation signal VS31 and the (3-2)-th operation signal VS32 may have opposite phases. For example, while the (3-1)-th operation signal VS31 has a value of “1,” the (3-2)-th operation signal VS32 may have a value of “0.”

For example, the switch controller 110 may perform the fifth operation using the (3-1)-th operation signal VS31 having a duty ratio of 50%. Also, the switch controller 110 may perform the sixth operation using the (3-2)-th operation signal VS32 having a duty ratio of 50%.

Accordingly, the switch controller 110 may alternately perform the fifth operation and the sixth operation at the same time interval using the (3-1)-th operation signal VS31 and the (3-2)-th operation signal VS32 having the same duty ratio.

Referring to FIG. 7A and FIG. 7B, when the switch controller 110 alternately performs the fifth operation and the sixth operation, a voltage having the same voltage value as the charging voltage VO (for example, VO) may be maintained in the third floating capacitor CF3 and the fourth floating capacitor CF4. The voltage source 108 may output a third input voltage VI3 having a voltage value of 2 times the charging voltage VO (for example, 2*VO). Therefore, the voltage value of the third input voltage VI3 (for example, 2*VO) may be maintained at the input node N1 of the voltage conversion circuit 100A.

A current (for example, 0.5IO) smaller than the charging current IO may flow through each of the third floating capacitor CF3 and the fourth floating capacitor CF4.

When the switch controller 110 alternately performs the fifth operation and the sixth operation, the currents (for example, 0.5IO) flowing through each of the third floating capacitor CF3 and the fourth floating capacitor CF4 may be summed at the output node NO and then output as the charging current IO.

For example, the switch controller 110 may control at least a portion of the plurality of switches SW1 to SW16 included in the voltage conversion circuit 100A such that the voltage conversion circuit 100A outputs the charging current IO from the third input voltage VI3 having a voltage value of 2 times the charging voltage VO.

Accordingly, as the third input voltage VI3 that is 2 times the charging voltage VO is applied to the voltage conversion circuit 100A from the voltage source 108, the voltage converter 10A may operate as a 2:1 voltage converter outputting the charging current IO.

Referring to FIG. 3A to FIG. 3C, FIG. 5A to FIG. 6, and FIGS. 7A and 7B, the voltage converter 10A may convert each of a plurality of different input voltages VI1, VI2, and VI3 into the charging voltage VO by controlling the single voltage conversion circuit 100. In addition, the voltage converter 10 may output the charging current IO based on the charging voltage VO.

For example, the voltage converter 10A may operate as a 3:1 voltage converter, a 4:1 voltage converter, or a 2:1 voltage converter under the control of the switch controller 110.

Thus, the voltage converter 10A according to some example embodiments may be implemented with a relatively small area compared to the case of including a plurality of conversion circuits converting each of a plurality of different input voltages into the charging voltage VO.

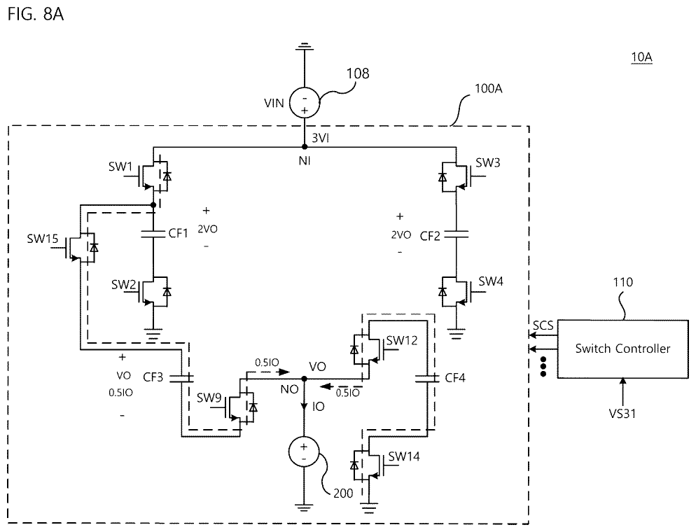

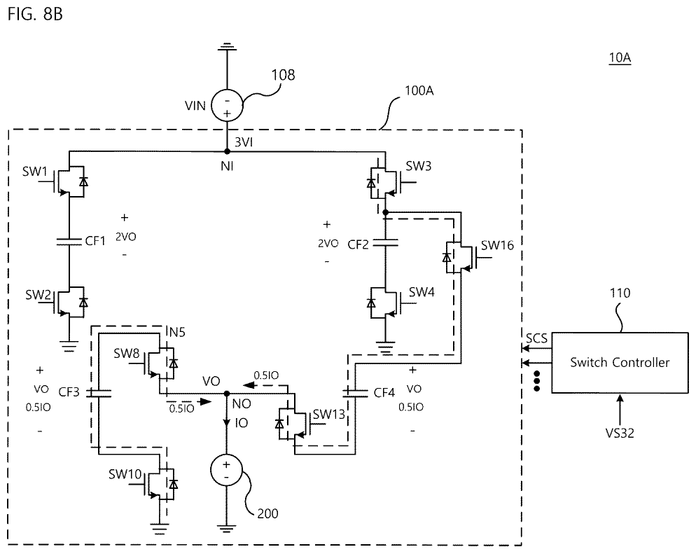

FIG. 8A is a circuit diagram illustrating a flow of current in the voltage conversion circuit while the switch controller performs the fifth operation according to some example embodiments. FIG. 8B is a circuit diagram illustrating a flow of current in the voltage conversion circuit while the switch controller performs the sixth operation according to some example embodiments.

Referring to FIG. 8A and FIG. 8B, the switch controller 110 according to some example embodiments may control at least a portion of the plurality of switches SW1 to SW16 included in the voltage conversion circuit 100A. Thus, the voltage conversion circuit 100A may output a charging current IO based on a third input voltage VI3.

The third input voltage VI3 may be understood to have a value of 2 times the charging voltage VO.

For example, the switch controller 110 may perform a fifth operation and a sixth operation of controlling at least a portion of the plurality of switches SW1 to SW16 included in the voltage conversion circuit 100A.

Referring to FIG. 8A, the switch controller 110 according to some example embodiments may perform a fifth operation of controlling at least a portion of the plurality of switches SW1 to SW16 such that the voltage conversion circuit 100A outputs the charging current IO based on a (3-1)-th operation signal VS31.

For example, in the fifth operation, the switch controller 110 may turn on the first switch SW1 and the fifteenth switch SW15 to connect the third floating capacitor CF3 to the voltage source 108 or an input node N1.

In the fifth operation, the switch controller 110 may also turn on the fourteenth switch SW14 to connect the fourth floating capacitor CF4 to ground.

In the fifth operation, the switch controller 110 may also turn on the ninth switch SW9 and the twelfth switch SW12 to connect the third floating capacitor CF3 and the fourth floating capacitor CF4 to an output node NO.

For example, the switch controller 110 may perform the fifth operation of connecting the third floating capacitor CF3 to the voltage source 108 and the output node NO, and connecting the fourth floating capacitor CF4 to the ground and the output node NO.

In the fifth operation, the switch controller 110 may turn off the fifth switch SW5, the seventh switch SW7, the eighth switch SW8, the tenth switch SW10, the eleventh switch SW11, the thirteenth switch SW13, and the sixteenth switch SW16.

Referring to FIG. 8B, the switch controller 110 according to some example embodiments may perform a sixth operation of controlling at least a portion of the plurality of switches SW1 to SW16 such that the voltage conversion circuit 100A outputs the charging current IO based on a (3-2)-th operation signal VS32.

For example, in the sixth operation, the switch controller 110 may turn on the third switch SW3 and the sixteenth switch SW16 to connect the fourth floating capacitor CF4 to the voltage source 108 (or an input node N1).

In the sixth operation, the switch controller 110 may also turn on the tenth switch SW10 to connect the third floating capacitor CF3 to ground.

In the sixth operation, the switch controller 110 may turn on the eighth switch SW8 and the thirteenth switch SW13 to connect the third floating capacitor CF3 and the fourth floating capacitor CF4 to an output node NO.

For example, the switch controller 110 may perform the sixth operation of connecting the third floating capacitor CF3 to ground and the output node NO, and connecting the fourth floating capacitor CF4 to the voltage source 108 and the output node NO.

In the sixth operation, the switch controller 110 may turn off the fifth switch SW5, the sixth switch SW6, the seventh switch SW7, the ninth switch SW9, the eleventh switch SW11, the twelfth switch SW12, the fourteenth switch SW14, and the fifteenth switch SW15.

According to some example embodiments, the switch controller 110 may alternately perform the fifth and sixth operations using a (3-1)-th operation signal VS31 and a (3-2)-th operation signal VS32, respectively.

For example, the switch controller 110 may alternately perform the fifth and sixth operations using the (3-1)-th operation signal VS31 and the (3-2)-th operation signal VS32, each having a predetermined (or, alternative, determined or desired) duty cycle.

For example, each of the (3-1)-th operation signal VS31 and the (3-2)-th operation signal VS32 may have a duty cycle of 50%. Therefore, the (3-1)-th operation signal VS31 and the (3-2)-th operation signal VS32 may be alternately maintained at “1” and “0” for the same duration t1, respectively.

Also, the (3-1)-th operation signal VS31 and the (3-2)-th operation signal VS32 may have opposite phrases. For example, while the (3-1)-th operation signal VS31 has a value of “1,” the (3-2)-th operation signal VS32 may have a value of “0.”

For example, the switch controller 110 may perform the fifth operation using the (3-1)-th operation signal VS31 with a duty cycle of 50%. Also, the switch controller 110 may perform the sixth operation using the (3-2)-th operation signal VS32 with a duty cycle of 50%.

Accordingly, the switch controller 110 may alternately perform the fifth and sixth operations at the same time intervals using the (3-1)-th operation signal VS31 and the (3-2)-th operation signal VS32 having the same duty cycle.

Referring to FIG. 8A and FIG. 8B, when the switch controller 110 alternately performs the fifth and sixth operations, a voltage having the same voltage value as the charging voltage VO (for example, 2VO) may be maintained in the third floating capacitor CF3 and the fourth floating capacitor CF4. The voltage source 108 may output a third input voltage VI3 having a voltage value twice the charging voltage VO. Accordingly, the voltage value of the third input voltage VI3 2VO may be maintained at the input node N1 of the voltage conversion circuit 100A.

A current (for example, 0.5IO) smaller than the charging current IO may flow through each of the third floating capacitor CF3 and the fourth floating capacitor CF4.

When the switch controller 110 alternately performs the fifth and sixth operations, the currents (for example, 0.5IO) flowing through each of the third floating capacitor CF3 and the fourth floating capacitor CF4 may be summed at the output node NO and then output as the charging current IO.

For example, the switch controller 110 may control at least a portion of the plurality of switches SW1 to SW16 included in the voltage conversion circuit 100A such that the voltage conversion circuit 100A outputs the charging current IO from the third input voltage VI3 having a voltage value of 2 times the charging voltage VO.

Accordingly, as the third input voltage VI3 that is 2 times the charging voltage VO is applied to the voltage conversion circuit 100A from the voltage source 108, the voltage converter 10A may operate as a 2:1 voltage converter outputting the charging current IO.

Referring to FIG. 3A to FIG. 3C, FIG. 5A to FIG. 6, and FIGS. 8A and 8B, the voltage converter 10A may convert each of a plurality of different input voltages VI1, VI2, and VI3 into the charging voltage VO by controlling the single voltage conversion circuit 100. In addition, the voltage converter 10 may output the charging current IO based on the charging voltage VO.

For example, the voltage converter 10A may operate as a 3:1 voltage converter, a 4:1 voltage converter, or a 2:1 voltage converter under the control of the switch controller 110.

Thus, the voltage converter 10A according to some example embodiments may be implemented with a relatively small area compared to the case of including a plurality of conversion circuits converting each of a plurality of different input voltages into the charging voltage VO.

Referring to FIGS. 8A and 8B, the switch controller 110 may turn on the first switch SW1, the second switch SW2, the third switch SW3, and the fourth switch SW4 in response to a (3-1)-th operation signal VS31 and a (3-2)-th operation signal VS32.

For example, the switch controller 110 may maintain the first switch SW1, the second switch SW2, the third switch SW3, and the fourth switch SW4 in an ON state while alternately performing the fifth and sixth operations.

While the switch controller 110 alternately performs the fifth and sixth operations, a voltage (for example, 2*VO) having a voltage value of 2 times the charging voltage VO may be maintained in each of the first floating capacitor CF1 and the second floating capacitor CF2.

Thus, the voltage converter 10A according to some example embodiments may reduce switching loss caused by turning the switches on and off while alternately performing the fifth and sixth operations.

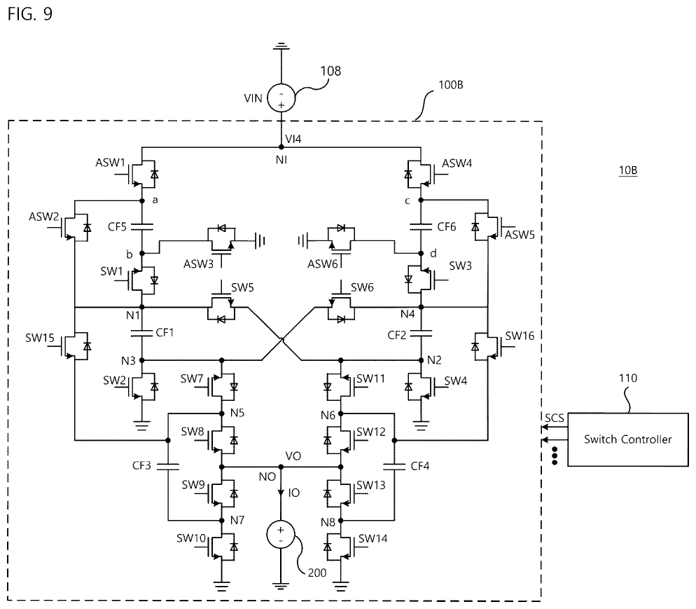

FIG. 9 is a circuit diagram of a voltage converter further including a plurality of additional switches and a plurality of floating capacitors according to some example embodiments.

Referring to FIG. 9, the voltage converter 10B according to some example embodiments may include a voltage conversion circuit 100B and a switch controller 110.

Also, the voltage conversion circuit 100B may include a plurality of switches SW1 to SW16, floating capacitors CF1 to CF6, and a plurality of additional switches ASW1 to ASW6.

The voltage converter 10B and the voltage conversion circuit 100B illustrated in FIG. 9 may be understood as examples of the voltage converter 10 and the voltage conversion circuit 100 illustrated in FIG. 1, respectively. Therefore, the same or substantially the same components are represented by the same reference numerals, and redundant descriptions will be omitted to avoid repetition.

In addition, the voltage conversion circuit 100B illustrated in FIG. 9 may be referred to as a configuration further including a plurality of additional switches ASW1 to ASW6, a fifth floating capacitor CF5, and a sixth floating capacitor CF6, based on the configuration of the voltage conversion circuit 100A illustrated in FIG. 2A.

The voltage conversion circuit 100B may include a fifth floating capacitor CF5 connected to the first switch SW1. For example, the voltage conversion circuit 100B may include a fifth floating capacitor CF5 connected to a drain electrode of the first switch SW1.

The voltage conversion circuit 100B may include the first additional switch ASW1 connected between the fifth floating capacitor CF5 and a voltage source 108.

The voltage conversion circuit 100B may include the second additional switch ASW2 connected between a point “a” between the fifth floating capacitor CF5 and the first additional switch ASW1 and a first node N1.

The voltage conversion circuit 100B may include the third additional switch ASW3 connected between a point “b” between the fifth floating capacitor CF5 and the first switch SW1 and ground.

The voltage conversion circuit 100B may include the sixth floating capacitor CF6 connected to the third switch SW3. For example, the voltage conversion circuit 100B may include a sixth floating capacitor CF6 connected to a drain electrode of the third switch SW3.

The voltage conversion circuit 100B may include the fourth additional switch ASW4 connected between the sixth floating capacitor CF6 and the voltage source 108.

The voltage conversion circuit 100B may include the fifth additional switch ASW5 connected between a point “c” between the sixth floating capacitor CF6 and the fourth additional switch ASW4 and a fourth node N4.

The voltage conversion circuit 100B may include a sixth additional switch ASW6 connected between a point “d” between the sixth floating capacitor CF6 and the third switch SW3 and ground.

According to some example embodiments, when the fourth input voltage VI4 has a voltage value of 5 times the charging voltage VO (for example, 5*VO), the switch controller 110 may control at least a portion of the plurality of switches SW1 to SW16 and the plurality of additional switches ASW1 to ASW6 such that the voltage conversion circuit 100B outputs the charging current IO from the fourth input voltage VI4.

For example, the switch controller 110 may alternately perform a seventh operation of turning on a plurality of switches including the first additional switch ASW1 and an eighth operation of turning on a plurality of switches including the fourth additional switch ASW4.

As the switch controller 110 alternately performs the seventh operation and the eighth operation, a voltage having a voltage value of 2 times the charging voltage VO (for example, 2*VO) may be maintained in each of the fifth floating capacitor CF5 and the sixth floating capacitor CF6.

In addition, as the switch controller 110 alternately performs the seventh and eighth operations, a voltage having a voltage value of twice the charging voltage VO (for example, 2*VO) may be maintained in each of the first floating capacitor CF1 and the second floating capacitor CF2.

In addition, as the switch controller 110 alternately performs the seventh and eighth operations, a voltage having the same voltage value as the charging voltage VO (for example, VO) may be maintained in each of the third floating capacitor CF3 and the fourth floating capacitor CF4.

Thus, when the voltage source 108 outputs a fourth input voltage VI4 having a voltage value of 5 times the charging voltage VO (for example, 5*VO), the voltage converter 10B may convert the input voltage VIO into the charging voltage VO through the voltage conversion circuit 100B.

In addition, the voltage converter 10B may output the charging voltage VO based on the charging voltage VO through the voltage conversion circuit 100B.

For example, the voltage converter 10B may operate as a 5:1 voltage converter outputting the charging current IO as the fourth input voltage VI4, which is 5 times the charging voltage VO, is applied from the voltage source 108 to the voltage conversion circuit 100B.

According to some example embodiments, when the fourth input voltage VI4 has a voltage value of 6 times the charging voltage VO (for example, 6*VO), the switch controller 110 may control at least a portion of the plurality of switches SW1 to SW16 and the plurality of additional switches ASW1 to ASW6 such that the voltage conversion circuit 100B outputs the charging current IO from the fourth input voltage VI4.

For example, the switch controller 110 may alternately perform a ninth operation of turning on a plurality of switches including the first additional switch ASW1 and a tenth operation of turning on a plurality of switches including the fourth additional switch ASW4.

Thus, when the voltage source 108 outputs a fourth input voltage VI4 having a voltage value of 6 times the charging voltage VO (for example, 6*VO), the voltage converter 10B may convert the input voltage VIO into the charging voltage VO through the voltage conversion circuit 100B.

In addition, the voltage converter 10B may output the charging voltage VO based on the charging voltage VO through the voltage conversion circuit 100B.

For example, the voltage converter 10B may operate as a 6:1 voltage converter outputting the charging current IO as the fourth input voltage VI4, which is 6 times the charging voltage VO, is applied from the voltage source 108 to the voltage conversion circuit 100B.

Referring to the above-described configurations, the voltage conversion circuit 100B according to some example embodiments may further include a plurality of additional switches ASW1 to ASW6, the fifth floating capacitor CF5, and a sixth floating capacitor CF6, compared to the voltage conversion circuit 100A illustrated in FIG. 2A.

Thus, the voltage converter 10B may control the voltage conversion circuit 100B through the switch controller 110 to convert the fourth input voltage VI4 having a voltage value of 5 or 6 times the charging voltage VO into the charging voltage VO.

For example, the voltage converter 10B may operate not only as a 2:1 voltage converter, a 3:1 voltage converter, and a 4:1 voltage converter, but also as a 5:1 voltage converter and a 6:1 voltage converter.

According to some example embodiments, the voltage converter 10B may further include an additional floating capacitor, connected to a point between the first additional switch ASW1 and the input node N1, and three switches connected to the additional floating capacitor.

Each of the three switches may be connected to the additional floating capacitor to correspond to the first additional switch ASW1 through the third additional switch ASW3. For example, the three switches may be connected between the additional floating capacitor and the input node N1, between the additional floating capacitor and ground, and between the additional floating capacitor and the second additional switch ASW2, respectively.

The voltage converter 10B may further include an additional floating capacitor connected to a point between the fourth additional switch ASW4 and the input node N1, and three switches connected to the additional floating capacitor.

Each of the three switches may be connected to the additional floating capacitor to correspond to the fourth additional switch ASW4 through the sixth additional switch ASW6. For example, the three switches may be connected between the additional floating capacitor and the input node N1, between the additional floating capacitor and ground, and between the additional floating capacitor and the fifth additional switch ASW5, respectively.

The voltage converter 10B may be controlled through the switch controller 110 such that the voltage conversion circuit 100B converts the fourth input voltage VI4, which has a voltage value of 7 or 8 times the charging voltage VO, into the charging voltage VO.

For example, the voltage converter 10B may also operate as a 7:1 voltage converter and an 8:1 voltage converter.

Accordingly, as a total of six switches and two floating capacitors are added to the voltage conversion circuit 100B according to some example embodiments, a conversion ratio that may be implemented through the voltage conversion circuit 100B may be increased.

For example, when a total of six switches and two floating capacitors are further added to the voltage conversion circuit 100B, the voltage converter 10B may also operate as a 9:1 voltage converter and a 10:1 voltage converter.

Referring to the above-described configurations, the voltage converter 10B according to some example embodiments may convert the fourth input voltage VI4, which has a voltage value an integer multiple of the charging voltage VO, to output the charging current IO.

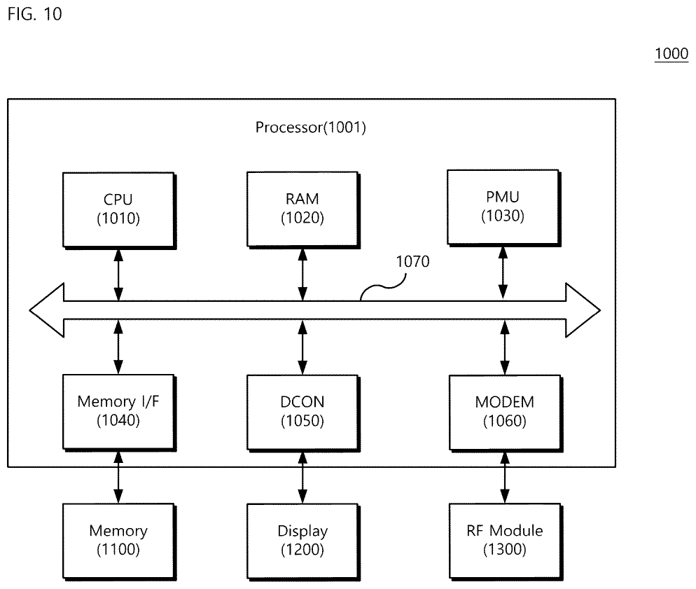

FIG. 10 is a block diagram of a mobile terminal including a voltage converter according to some example embodiments.

Referring to FIG. 10, a mobile terminal 1000 may include a processor 1001, a memory 1100, a display 1200, and a radio-frequency (RF) module 1300. The mobile terminal 1000 may further include various components such as a lens, a sensor, an audio module, or the like.

The processor 1001 may be implemented as a system-on-chip (SoC) and may include a central processing unit (CPU) 1010, RAM 1020, a power management unit (PMU) 1030, a memory interface (I/F) 1040, a display controller (DCON) 1050, a modem 1060, and a bus 1070. The processor 1001 may further include various IPs in addition to these. The processor 1001 may be referred to as a ModAP as functions of a modem chip are integrated therein, but example embodiments are not limited thereto.

The CPU 1010 may control the overall operation of the processor 1001 and the mobile terminal 1000. The CPU 1010 may control the operation of each component of the processor 1001. Also, the CPU 1010 may be designed with as multicore architecture. The multicore architecture includes a single computing component with two or more independent cores.

The RAM 1020 may temporarily store programs, data, or instructions. For example, programs and/or data stored in memory 1100 may be temporarily stored in the RAM 1020 under the control of the CPU 1010 or based on a booting code. The RAM 1020 may be implemented as a DRAM or an SRAM.

The PMU 1030 may manage the power of each component of the processor 1001. Also, the PMU 1030 may determine an operating status of each component of the processor 1001 and control an operation thereof.

The PMU 1030 according to some example embodiments may include the voltage converter 10 illustrated in FIG. 1. Therefore, the PMU 1030 may include a voltage conversion circuit 100 and a switch controller 110.

The switch controller 110 may control at least a portion of the plurality of switches SW1 to SW16 included in the voltage conversion circuit 100 such that the voltage conversion circuit 100 outputs the charging current IO.

According to some example embodiments, the switch controller 110 may turn on at least a portion of the plurality of switches SW1 to SW16 such that the voltage conversion circuit 100 outputs the charging current IO from the first input voltage VI1 having a voltage value of a first integer multiple (for example, 3 times) of the charging voltage VO.

The switch controller 110 may alternately perform the first operation and the second operation of turning on at least a portion of the plurality of switches SW1 to SW16 such that the voltage conversion circuit 100 outputs the charging current IO.

For example, the switch controller 110 may alternately perform the first operation and the second operation in response to two signals that have the same duty ratio and are in opposite phrases.

Also, the switch controller 110 may turn on a portion of the plurality of switches SW1 to SW16 such that the voltage conversion circuit 100 outputs the charging current IO from the second input voltage VI2 having a voltage value of a second integer multiple (for example, 4 times) of the charging voltage VO.

The switch controller 110 may alternately perform the third operation and the fourth operation of turning on at least a portion of the plurality of switches SW1 to SW16 such that the voltage conversion circuit 100 outputs the charging current IO. For example, the switch controller 110 may repeatedly and alternately perform the third operation and the fourth operation at the same time interval.

Also, the switch controller 110 may turn on a portion of the plurality of switches SW1 to SW16 such that the voltage conversion circuit 100 outputs the charging current IO from the third input voltage VI3 having a voltage value of a third integer multiple (for example, twice) of the charging voltage VO.

The switch controller 110 may alternately perform a fifth operation and a sixth operation of turning on at least a portion of the plurality of switches SW1 to SW16 such that the voltage conversion circuit 100 outputs the charging current IO. For example, the switch controller 110 may repeatedly and alternately perform the fifth operation and the sixth operation at the same time interval.

Referring to the above-described configurations, the voltage converter 10 according to some example embodiments may output the charging current IO based on the charging voltage VO from different input voltages VI1, VI2, and VI3 having voltage values that are multiples of the charging voltage VO.

For example, the voltage converter 10 may convert each of a plurality of different input voltages into the charging voltage VO by controlling a single voltage conversion circuit 100. In addition, the voltage converter 10 may output the charging current IO based on the charging voltage VO.

Thus, the voltage converter 10 according to some example embodiments may be implemented with a relatively small area compared to the case of including a plurality of conversion circuits converting each of a plurality of different input voltages into the charging voltage VO.

The memory interface 1040 may control the overall operation of the memory 1100 and may control data exchange between each component of the processor 1001 and the memory 1100. The memory interface 1040 may write data in the memory 1100 or read data from the memory 1100 based on a request of the CPU 1010.

The display controller 1050 may transmit image data to be displayed on the display 1200 to the display 1200. The display 1200 may be implemented as a flat panel display such as a liquid crystal display (LCD) or an organic light-emitting diode (OLED), or as a flexible display.

The modem 1060 may modulate data to be transmitted to be appropriate to a wireless environment and recover received data. The modem 1060 may perform digital communication with the RF module 1300.

The RF module 1300 may convert a high-frequency signal received through antennas into a low-frequency signal and transmit the converted low-frequency signal to the modem 1060. In addition, the RF module 1300 may convert the low-frequency signal, received from the modem 1060, into a high-frequency signal and transmit the converted high-frequency signal to the outside of the mobile terminal 1000 through the antennas. The RF module 1300 may amplify or filter signals.

As described above, the voltage converter 10 according to some example embodiments may output the charging current IO based on the charging voltage VO from different input voltages VI1, VI2, and VI3 having voltage values that are multiples of the charging voltage VO.

The voltage converter 10 according to some example embodiments may alternately perform two different operations of controlling at least a portion of the plurality of switches SW1 to SW16 such that the voltage conversion circuit 100 outputs the charging current IO.

For example, the voltage converter 10 may convert each of a plurality of different input voltages into the charging voltage VO by controlling a single voltage conversion circuit 100. In addition, the voltage converter 10 may output the charging current IO based on the charging voltage VO.

Thus, the voltage converter 10 according to some example embodiments may be implemented with a relatively small area compared to the case of including a plurality of conversion circuits converting each of a plurality of different input voltages into the charging voltage VO.

When the voltage source 108 outputs the third input voltage VI3 having a voltage value of twice the charging voltage VO, the voltage converter 10 according to some example embodiments may maintain a portion of the switches (for example, the first switch SW1 to the fourth switch SW4) in an ON state while alternately performing the fifth operation and the sixth operation.

Thus, the voltage converter 10 according to some example embodiments may reduce switching loss caused by turning the switches on and off while alternately performing different operations.

In the third operation, when the voltage source 108 outputs the second input voltage VI2 having a voltage value of 4 times the charging voltage VO, the voltage converter 10 according to some example embodiments may turn on the sixth switch SW6 after a certain time from the time at which the first switch SW1 is turned on. In the fourth operation, the voltage converter 10 may turn on the fifth switch SW5 after a certain time from the time at which the third switch SW3 is turned on.

As a result, the voltage converter 10 according to some example embodiments may reduce an on-breakdown voltage ON BV applied to the fifth switch SW5 and the sixth switch SW6. Also, the voltage conversion circuit 100 may be configured with switches having a relatively low breakdown voltage.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

As set forth above, according to example embodiments, voltage converters may reduce an area required to output a charging current from a plurality of different input voltages.

While example embodiments have been shown and described above, it will be apparent to those skilled in the art that modifications and variations could be made without departing from the scope of the present inventive concepts as defined by the appended claims.

What is claimed is:

1. A voltage converter, the voltage converter comprising:
a plurality of switches;
a first floating capacitor and a second floating capacitor;
a third floating capacitor and a fourth floating capacitor, each connected to an output node configured to output a charging current; and
a switch controller configured to control the plurality of switches,
wherein the switch controller is configured to control the plurality of switches in response to a first voltage control signal, based on a first input voltage, having a first ratio with respect to a charging voltage based on the charging current, being applied from a voltage source, to alternatively perform:
a first operation of connecting the first floating capacitor to the voltage source, connecting the third floating capacitor to ground, and connecting the second floating capacitor and the fourth floating capacitor in series between the ground and the output node; and
a second operation of connecting the first floating capacitor and the third floating capacitor in series between the ground and the output node, connecting the second floating capacitor to the voltage source, and connecting the fourth floating capacitor to the ground.

2. The voltage converter of claim 1, comprising:
a first switch connected between the voltage source and the first floating capacitor;
a second switch connected between the first floating capacitor and the ground;
a third switch connected between the voltage source and the second floating capacitor;
a fourth switch connected between the second floating capacitor and the ground;
a fifth switch connected between a first node between the first switch and the first floating capacitor and a second node between the second floating capacitor and the fourth switch;
a sixth switch connected between a third node between the first floating capacitor and the second switch and a fourth node between the third switch and the second floating capacitor;
a seventh switch, an eighth switch, a ninth switch, and a tenth switch connected in series between the third node and the ground;
an eleventh switch, a twelfth switch, a thirteenth switch, and a fourteenth switch connected in series between the second node and the ground;
a fifteenth switch connected between the first node and a fifth node between the seventh switch and the eighth switch; and
a sixteenth switch connected between the fourth node and a sixth node between the eleventh switch and the second switch.

3. The voltage converter of claim 2, wherein:
the third floating capacitor is connected between the fifth node and a seventh node between the ninth switch and the tenth switch; and
the fourth floating capacitor is connected between the sixth node and an eighth node between the thirteenth switch and the fourteenth switch.

4. The voltage converter of claim 2, wherein:
the output node is commonly connected between the eighth switch and the ninth switch, and between the twelfth switch and the thirteenth switch; and
the switch controller is configured to alternately perform the first operation and the second operation such that the voltage converter outputs the charging current through the output node from a voltage applied from the voltage source.

5. The voltage converter of claim 4, wherein:
the switch controller is configured to:
turn on the first switch, the fourth switch, the seventh switch, the eighth switch, the tenth switch, the thirteenth switch, and the sixteenth switch in the first operation; and
turn on the third switch, the fifth switch, the sixth switch, the ninth switch, the eleventh switch, the fourteenth switch, and the fifteenth switch in the second operation.

6. The voltage converter of claim 1, wherein:
the switch controller is configured to:
perform the first operation using a (1-1)-th operation signal having a duty ratio; and
perform the second operation using a (1-2)-th operation signal having the duty ratio and an inverse phase to the (1-1)-th operation signal.

7. The voltage converter of claim 2, wherein:
the switch controller is configured to control the plurality of switches in response to a second voltage control signal, based on a second input voltage, greater than the first input voltage, being applied from the voltage source, to alternatively perform:
a third operation of connecting the first floating capacitor to the voltage source, connecting the third floating capacitor to the first floating capacitor and the second floating capacitor, and connecting the second floating capacitor and the fourth floating capacitor to the ground; and
a fourth operation of connecting the first floating capacitor and the third floating capacitor to the ground, connecting the second floating capacitor to the voltage source, and connecting the fourth floating capacitor to the first floating capacitor and the second floating capacitor.

8. The voltage converter of claim 7, wherein:
the switch controller is configured to:
turn on the first switch, the fourth switch, the sixth switch, the seventh switch, the ninth switch, the twelfth switch, and the fourteenth switch in the third operation; and
turn on the second switch, the third switch, the fifth switch, the eighth switch, the tenth switch, the eleventh switch, and the thirteenth switch in the fourth operation.

9. The voltage converter of claim 8, wherein:
the switch controller, in the third operation, is configured to:
turn on the first switch, the fourth switch, the seventh switch, the ninth switch, the twelfth switch, and the fourteenth switch in response to a (2-1)-th operation signal; and
turn on the sixth switch after a time interval from a time at which the first switch is turned on.

10. The voltage converter of claim 2, wherein:
the switch controller is configured to control the plurality of switches in response to a third voltage control signal, based on a third input voltage, smaller than the first input voltage, being applied from the voltage source, to alternatively perform:
a fifth operation of connecting the third floating capacitor to the voltage source and connecting the fourth floating capacitor to the ground; and
a sixth operation of connecting the third floating capacitor to the ground and connecting the fourth floating capacitor to the voltage source.

11. The voltage converter of claim 10, wherein:
the switch controller is configured to:
turn on the first switch, the ninth switch, the twelfth switch, the fourteenth switch, and the fifteenth switch in the fifth operation; and
turn on the third switch, the eighth switch, the tenth switch, the thirteenth switch, and the sixteenth switch in the sixth operation.

12. The voltage converter of claim 10, wherein:
the switch controller is configured to turn on the first switch, the second switch, the third switch, and the fourth switch while alternately performing the fifth operation and the sixth operation.

13. The voltage converter of claim 7, further comprising:
a fifth floating capacitor connected to the first switch;
a first additional switch connected between the fifth floating capacitor and the voltage source;
a second additional switch connected between a point between the fifth floating capacitor and the first additional switch and the first node;
a third additional switch connected between a point between the fifth floating capacitor and the first additional switch and the ground;
a sixth floating capacitor connected to the third switch;
a fourth additional switch connected between the sixth floating capacitor and the voltage source;
a fifth additional switch connected between a point between the sixth floating capacitor and the fourth additional switch and the fourth node; and
a sixth additional switch connected between a point between the sixth floating capacitor and the fourth additional switch and the ground,
wherein the switch controller is configured to control at least a portion of the plurality of switches such that the voltage source generates a fourth input voltage greater than the second input voltage.

14. A voltage conversion circuit, the voltage conversion circuit comprising:
a plurality of switches;
a first switch and a second switch connected in series between a voltage source and ground;
a first floating capacitor connected between the first switch and the second switch;
a third switch and a fourth switch connected in parallel to the first switch and the second switch between the voltage source and the ground;
a second floating capacitor connected between the third switch and the fourth switch;
a fifth switch connected between a first node between the first switch and the first floating capacitor and a second node between the second floating capacitor and the fourth switch;
a sixth switch connected between a third node between the first floating capacitor and the second switch and a fourth node between the third switch and the second floating capacitor;
a seventh switch, an eighth switch, a ninth switch, and a tenth switch connected in series between the third node and the ground;
an eleventh switch, a twelfth switch, a thirteenth switch, and a fourteenth switch connected in series between the second node and the ground;
a fifteenth switch connected between the first node and a fifth node between the seventh switch and the eighth switch;
a sixteenth switch connected between the fourth node and a sixth node between the eleventh switch and the twelfth switch;
a third floating capacitor connected between the fifth node and a seventh node between the ninth switch and the tenth switch; and
a fourth floating capacitor connected between the sixth node and an eighth node between the thirteenth switch and the fourteenth switch.

15. The voltage conversion circuit of claim 14, further comprising:
a switch controller electrically connected to the plurality of switches,
wherein the switch controller is configured to control the plurality of switches in response to a first voltage control signal, based on a first input voltage, having a first ratio with respect to a charging voltage of an output node, being applied from the voltage source, to alternately perform:
a first operation of connecting the first floating capacitor to the voltage source, connecting the third floating capacitor to the ground, and connecting the second floating capacitor and the fourth floating capacitor in series between the ground and the output node; and
a second operation of connecting the first floating capacitor and the third floating capacitor in series between the ground and the output node, connecting the second floating capacitor to the voltage source, and connecting the fourth floating capacitor to the ground.

16. The voltage conversion circuit of claim 15, wherein:
the switch controller is configured to:
turn on the first switch, the fourth switch, the seventh switch, the eighth switch, the tenth switch, the thirteenth switch, and the sixteenth switch in the first operation; and
turn on the third switch, the fifth switch, the sixth switch, the ninth switch, the eleventh switch, the fourteenth switch, and the fifteenth switch in the second operation.

17. The voltage conversion circuit of claim 15, wherein the switch controller is configured to control the plurality of switches in response to a second voltage control signal, based on a second input voltage having a second ratio, greater than the first ratio, with respect to the charging voltage being applied from the voltage source, to alternately perform:
a third operation of connecting the first floating capacitor to the voltage source, connecting the third floating capacitor to the first floating capacitor and the second floating capacitor, and connecting the second floating capacitor and the fourth floating capacitor to the ground; and
a fourth operation of connecting the first floating capacitor and the third floating capacitor to the ground, connecting the second floating capacitor to the voltage source, and connecting the fourth floating capacitor to the first floating capacitor and the second floating capacitor.

18. The voltage conversion circuit of claim 15, wherein the switch controller is configured to control the plurality of switches in response to a third voltage control signal, based on a third input voltage having a third ratio, smaller than the first ratio, with respect to the charging voltage being applied from the voltage source, to alternately perform:
a fifth operation of connecting the first floating capacitor and the third floating capacitor in series between the voltage source and the output node and connecting the fourth floating capacitor to the ground; and
a sixth operation of connecting the third floating capacitor to the ground and connecting the second floating capacitor and the fourth floating capacitor in series between the voltage source and the output node.

19. The voltage conversion circuit of claim 15, further comprising:
a first gate driver connected to a gate electrode of each of the first switch and the third switch;
a second gate driver connected to a gate electrode of each of the fifth switch, the sixth switch, the seventh switch, and the eleventh switch;
a third gate driver connected to a gate electrode of the eighth switch and a gate electrode of the twelfth switch; and
a fourth gate driver connected to a gate electrode of the fifteenth switch and a gate of the sixteenth switch,
wherein:
the switch controller is configured to control the first to fourth gate drivers to turn on at least a portion of the plurality of switches.

20. A voltage converter comprising:
a voltage conversion circuit comprising a plurality of switches; and
a switch controller connected to the voltage conversion circuit and configured to control the plurality of switches,
wherein:
the voltage conversion circuit comprises
a first floating capacitor and a second floating capacitor; and
a third floating capacitor and a fourth floating capacitor, each connected to an output node; and
the switch controller is configured to control the plurality of switches such that the voltage conversion circuit outputs a charging current from a first input voltage, based on a voltage source generating the first input voltage, to alternately perform:
a first operation of connecting the first floating capacitor to the voltage source, connecting the third floating capacitor to ground, and connecting the second floating capacitor and the fourth floating capacitor in series between the ground and the output node; and
a second operation of connecting the first floating capacitor and the third floating capacitor in series between the ground and the output node, connecting the second floating capacitor to the voltage source, and connecting the fourth floating capacitor to the ground.
